(19) United States
(12) Patent Application Publication
(10) Pub. No.: US 2013/0302094 A1
(43) Pub. Date: Nov. 14, 2013

(54) DEVICE FOR TENSIONING AND GRIPPING A TUBULAR ELONGATED ELEMENT

(71) Applicant: René Antoine Maloberti, Champigny Sur Marne (FR)

(72) Inventor: René Antoine Maloberti, Champigny Sur Marne (FR)

(21) Appl. No.: 13/988,229

(22) PCT Filed: Nov. 22, 2011
(86) PCT No.: PCT/EP2011/070682

§ 371 Date: Jul. 19, 2013

(30) Foreign Application Priority Data
Nov. 23, 2010 (FR) 1059646

(51) Int. Cl. F16L 1/23

(52) U.S. Cl. CPC F16L 1/23
USPC 405/166

(57) ABSTRACT

The present disclosure relates to a device for tensioning and gripping a tubular elongated element (3), designed to be placed on a bottom of an expanse of water from a surface placement installation, characterized in that it includes six tracks (11) uniformly distributed around a circumference and forming a space between them for the passage of the elongated element, each track being rotated by motor means (17, 18) integrated into said track (11) and being supported by a reinforcing chassis that can be moved between a passive retracted position of the track (11) and an active position pressing said track (11) against the elongated element.

The present invention relates to a device for tensioning and gripping a tubular elongated element designed to be placed on the bottom of an expanse of water from a surface placement installation, for example such as a lay barge.

Hereafter, a tubular elongated element may for example comprise a rigid pipe with a single or double enclosure, a flexible pipe connected or not connected as defined in the normative documents API 17J and API 17B from the American Petroleum Institute (API), an underwater umbilical described in normative document API 17E, or a power cable.

Known for example in patents U.S. Pat. No. 6,371,694 and U.S. Pat. No. 5,348,423 are barges for laying an elongated element that include a placement tower equipped with a device for tensioning and gripping said elongated element. The elongated element is submerged in the water by passing through the placement tower on the one hand and a passage formed in the hull of the barge on the other hand.

The weight of the elongated elements during immersion thereof may be several hundred tons, which requires the use of a device for tensioning and gripping said elongated element so as to prevent it from falling in an uncontrolled manner on the bottom of the expanse of water. The tensioning and gripping device borne by the placement tower of the barge makes it possible to deploy the elongated element on the bottom in a controlled manner.

This type of device used to date comprises a set of tracks, of which there are 2, 3 or 4, which grip the elongated element. To that end, each track is supported by a reinforcing chassis that can be moved for example by cylinders between a retracted position and a position pressed against the elongated element to grip the elongated element with a predetermined force.

Each track is formed by a chain equipped with links bearing skates designed to be applied on the outer wall of the elongated element in the gripping position. Suitable motor means rotate the chain as well as the skates to apply the necessary tension on the elongated element during deployment thereof on the bottom of the expanse of water.

Currently, oil fields are increasingly deep, with the result that the lay barges must be higher performing to deploy the increasingly heavy loads, while complying with the bulk and stability constraints of the barges.

One solution to increase the gripping capacity consists of multiplying the tensioning and gripping devices on the placement tower by superimposing three or four devices. This solution has the drawback of increasing the height and weight of the tower, which poses problems for the stability of the barge.

Another solution consists of multiplying the number of tracks to tighten the tubular element. However, increasing the number of tracks must contend with the bulk, widthwise, of the chains and the skates, limiting the capacity to grip small diameters in light of the maximum possible gripping diameter.

The invention aims to propose a device for tensioning and gripping a tubular elongated element which, through means that are easy to implement, avoids these drawbacks and makes it possible to grip elongated elements with a small diameter.

The invention therefore relates to a device for tensioning and gripping a tubular elongated element, designed to be placed on a bottom of an expanse of water from a surface placement installation, characterized in that it includes six tracks uniformly distributed around a circumference and forming a space between them for the passage of the elongated element, each track being rotated by motor means integrated into said track and being supported by a reinforcing chassis that can be moved between a passive retracted position of the track and an active position pressing said track against the elongated element.

The device may also have one or more of the features below, considered individually or according to any technically possible combinations:
each track comprises a chain provided with several links supporting skates and forming a loop whereof the opposite ends include a toothed wheel meshing with the links of the chain and at least one of which is driven by said motor means,
the motor means comprise a reduction gear integrated into said toothed wheel and a bent hydraulic motor driving the reduction gear, and
the width of the skates of the chain of each track is comprised between 200 and 280 mm, and preferably approximately 265 mm.

The invention also relates to a barge for laying a tubular elongated element on a bottom of an expanse of water, comprising a placement tower equipped with a passage for said elongated element, characterized in that the placement tower bears at least one tensioning and gripping device for the elongated element as previously described.

The features and advantages of the invention will appear in the following description, provided as an example and done in reference to the appended drawings, in which:

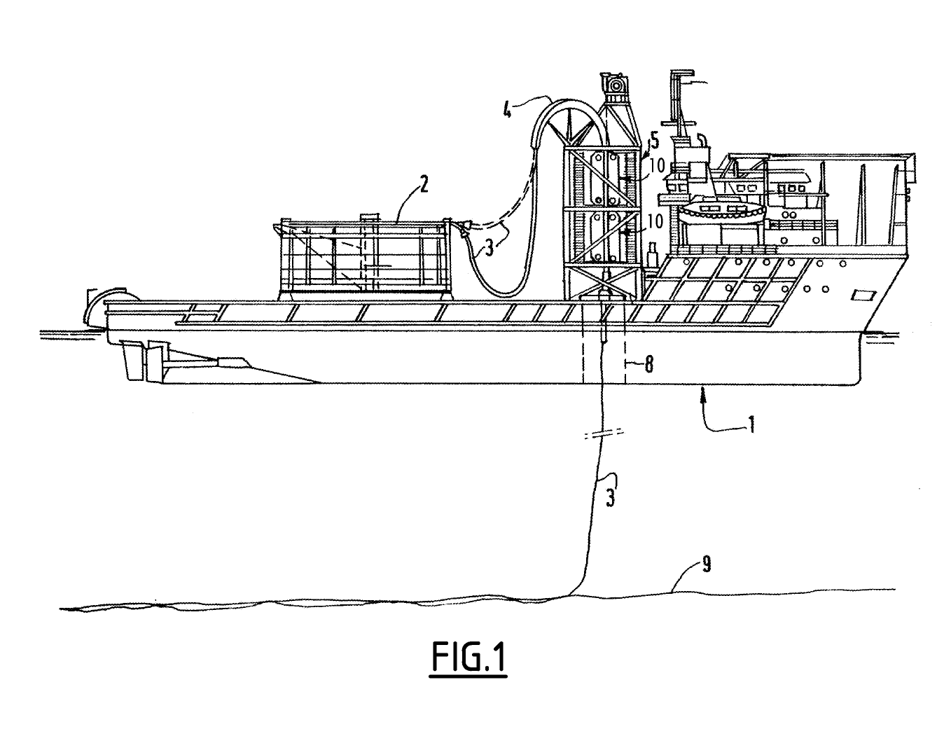

FIG. 1 is a profile view of a barge for laying a tubular elongated element using a tensioning and gripping device according to the invention,

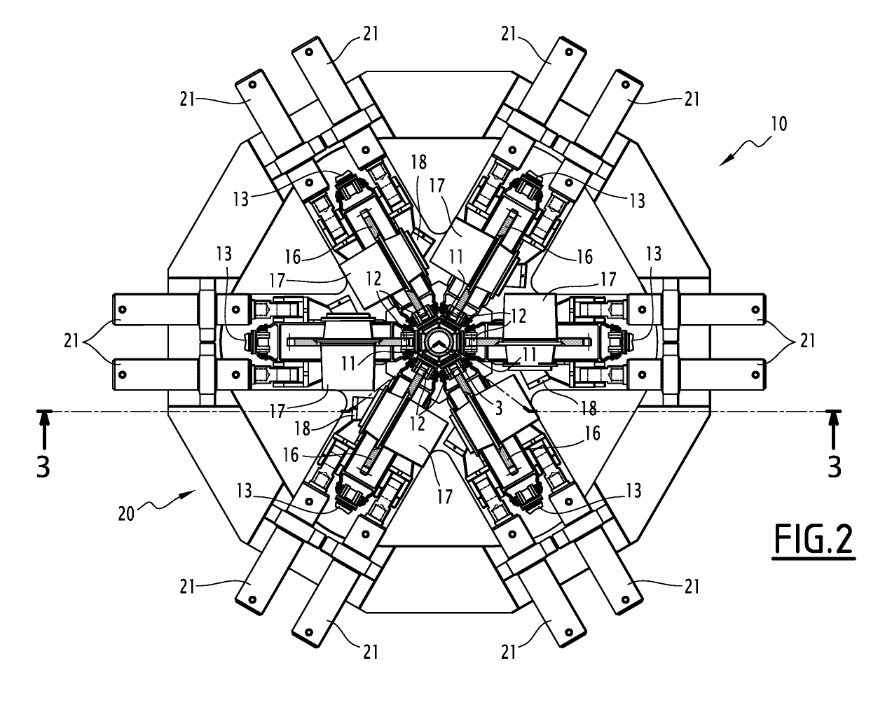

FIG. 2 is a diagrammatic transverse cross-sectional view of a tensioning and gripping device according to the invention,

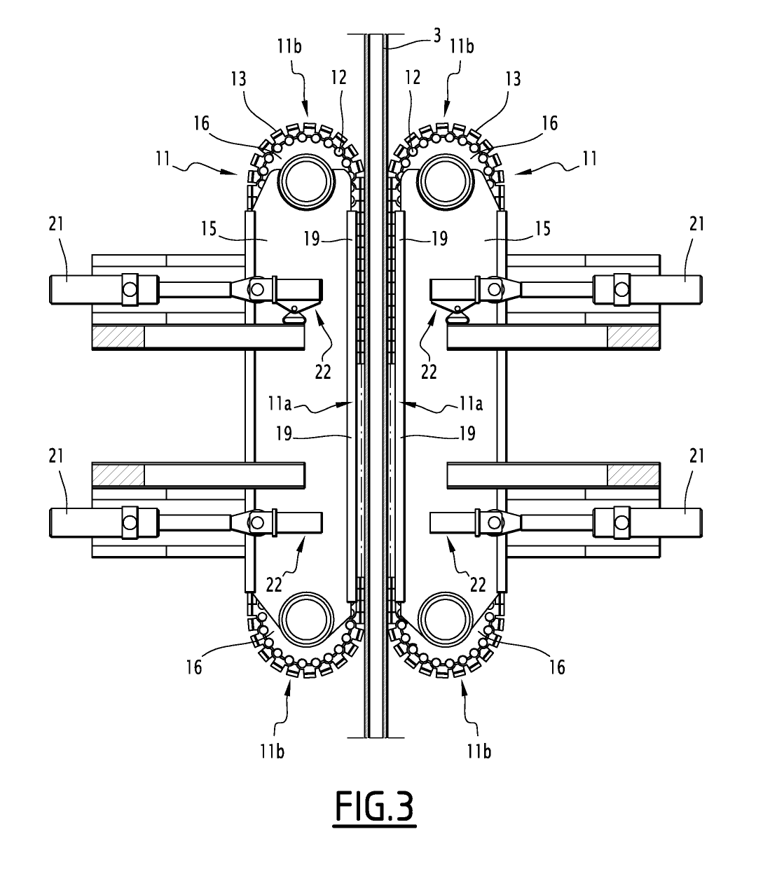

FIG. 3 is a diagrammatic cross-sectional view along line 3-3 of FIG. 2, and

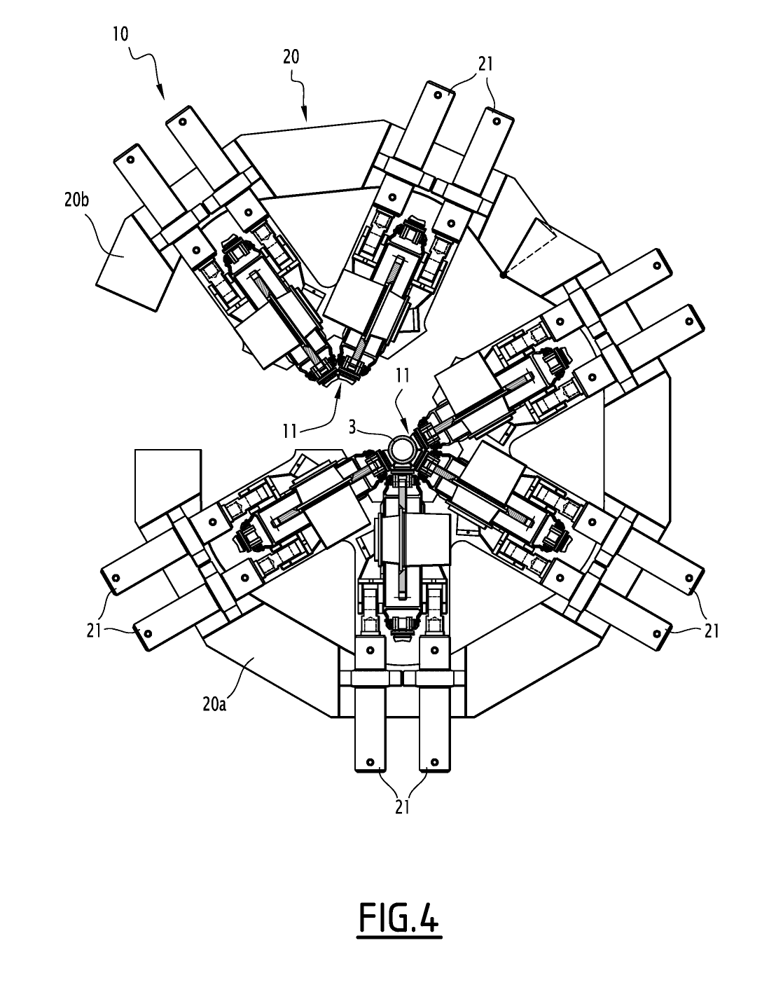

FIG. 4 is a diagrammatic top view of an alternative of the tensioning and gripping device according to the invention.

FIG. 1 diagrammatically shows a barge 1 equipped with an installation for laying a tubular elongated element 3 for example made up of segments connected to each other by connection tips of a known type, not shown. The lay barge 1 is of the type equipped with dynamic positioning means, not shown, and a moon pool 8 through which the elongated element 3 can be placed on the bottom 9 of the expanse of water.

This placement installation includes means 2 for storing the tubular element 3 which, in the example embodiment shown in FIG. 1, are made up of a basket with a substantially cylindrical shape with a vertical axis.

According to another embodiment, the storage means 2 may be made up of several winding coils of the tubular element 3.

The installation also includes a placement tower 5 provided, at the upper portion thereof, with means 4 for guiding the elongated element 3 that are for example formed by a neck 4 allowing the passage of said elongated element 3 in a vertical direction.

The placement tower 5 may optionally be tiltable.

Before being deployed on the bottom 9 of the expanse of water, the elongated element 3 passes over the neck 4 and in at least one tensioning and gripping device designated by general reference 10, then in a passage 8 formed in the hull of the barge 1.

Each of the tensioning and gripping devices 10, also called tensioner or caterpillar track, reacts part of the load. These devices 10 are positioned vertically in the placement tower 5 downstream from the guide means 4 and storage means 2. These devices 10 are designed to bear the weight of the elongated element 3 positioned vertically as far as the bottom 9 of the expanse of water.

In reference now to FIGS. 2 to 4, a tensioning and gripping device 10 of the tubular elongated element 3 will now be described.

As shown in FIG. 2, the device 10 comprises a set of tracks 11 and, more particularly, six tracks 11 uniformly distributed around a circumference and opposite one another two by two. The tracks 11 are all similar and form a space between them for passage of the elongated element 3.

As shown diagrammatically in FIG. 3, each track 11 is formed by a chain provided with links 12 bearing skates 13 designed to be pressed against the outer wall of the elongated element 3, as will be seen later.

The width of the skates 13 of the chain 12 is comprised between 200 and 280 mm, and preferably approximately 265 mm.

The chain 12 of each track 11 is supported by a reinforcing chassis 15, and said chain is rotated by motor means integrated into said track 11, as will be described later.

The support chassis 15 of each track is mounted on a same support structure 20 (FIG. 2) attached on the placement tower 5 of the barge 1. The reinforcing chassis 15 is connected to the support structure 20 using several sets of cylinders 21 so as to move the reinforcing chassis 15 and the skates 13 of the chain 12 of the track 11 between a passive retracted position of said track 11 and an active position pressing the skates 12 of said track 11 against the outer wall of the elongated element 3.

As shown in FIG. 3, each track 11 forms a loop having at least one rectilinear portion 11a in which the skates 13 of the chain 12 of said track 11 are in contact with the elongated element 3 to be kept in the active position. The loop has curved opposite ends 11b.

At each of its ends 11b, the chain 12 of the track 11 meshes on a toothed wheel 16, at least one of which is rotated by the motor means.

In the example embodiment shown in the figures, only the toothed wheel 16 of the curved upper end 11b of the loop described by the chain 11 is motorized.

According to the invention, and as shown in FIG. 2, the motor means comprise a reduction gear 17 integrated into the toothed wheel 16 and a bent hydraulic motor 18 driving the reduction gear 17.

Thus, when the motorized wheel 7 is actuated by the bent hydraulic motor 18 and the reduction gear 17, it moves the chain 12 and skates 13 of the track 11 around said motorized wheel 16 and the free wheel 16, which transmits the movement.

On the rectilinear trajectories of the chain 12, said chain 12 moves over a guide member 19 forming a rigid support for said chain. Each guide member is for example made up of a rail or bearings or bearing supports, as described in French patent application no. 1003564 dated Sep. 7, 2010, in the Applicant's name.

The body of each cylinder 21 is connected to the support structure 20 by a pivot 22 and the free end of the rod of each cylinder 21 is guided and connected to the reinforcing chassis 15 of the corresponding track 11 by an assembly designated using reference 22 and of a known type commonly used for this type of device.

According to another embodiment shown in FIG. 4, the support structure 20 is formed by two segments 20a and 20b articulated to each other, thereby making it possible for example to pivot the segment 20b to form a passage between the two segments 20a and 20b of the support structure 20.

The tensioning and gripping device with six tracks according to the invention allows significant gains in terms of height and weight of the placement tower of the barge, which allows the use of smaller boats, instability being the major factor in the sizing of a hull of a barge for such use.

The tensioning and gripping device according to the invention also makes it possible to improve the strength of the gripping of the elongated elements, while allowing said elongated element to be gripped by two or three or six tracks. The gripping in a three-track mode enables gripping of an elongated element with a smaller outer diameter than in the six-track mode.

Lastly, gripping the elongated element in six places allows greater tolerance with respect to the problem of deviation of the elongated element when upon entering the tensioning and gripping device.

1. A device for tensioning and gripping a tubular elongated element, designed to be placed on a bottom of an expanse of water from a surface placement installation, said device comprising six tracks uniformly distributed around a circumference and forming a space between them for the passage of the elongated element, each track being rotated by motor means integrated into said track and being supported by a reinforcing chassis that can be moved between a passive retracted position of the track and an active position pressing said track against the elongated element.

2. The device according to claim 1, wherein each track comprises a chain supporting skates and forming a loop whereof the opposite ends include a toothed wheel meshing with the links of the chain and at least one of which is driven by said motor means.

3. The device according to claim 2, wherein the motor means comprise a reduction gear integrated into said toothed wheel and a bent hydraulic motor driving the reduction gear.

4. The device according to claim 2, wherein the width of the skates of the chain of each track is comprised between 200 and 280 mm.

5. A barge for laying a tubular elongated element on a bottom of an expanse of water, comprising a placement tower equipped with a passage for said elongated element, wherein the placement tower bears at least one tensioning and gripping device for the elongated element according to claim 1.

6. The device according to claim 4 wherein the width of the skates of the chain of each track is approximately 265 mm.
